(19) United States
(12) Patent Application Publication
(10) Pub. No.: US 2024/0363902 A1
(43) Pub. Date: Oct. 31, 2024

(54) Electrolyte Additives that Reduce Gas Evolution in Li ion Batteries

(71) Applicant: STOREDOT LTD., Herzeliya (IL)

(72) Inventors: Shirel Cohen, Tel-Aviv (IL); Ilya Kisets, Ramat Gan (IL); John Dominic Herszman, Holon (IL)

(73) Assignee: STOREDOT LTD., Herzeliya (IL)

(21) Appl. No.: 18/645,351

(22) Filed: Apr. 24, 2024

Related U.S. Application Data
(60) Provisional application No. 63/498,234, filed on Apr. 25, 2023.

(51) Int. Cl. H01M 10/0567; H01M 10/0525; H01M 10/52

(52) U.S. Cl. CPC H01M 10/0567; H01M 10/0525; H01M 10/52

(57) ABSTRACT

A lithium ion cell that includes electrodes, an organic electrolyte; and a metal-free electrolyte additive that comprises an epoxide functional group configured to convert gaseous carbon dioxide generated during use of the lithium ion cell into liquid carbonate under ambient conditions.

### BACKGROUND

A lithium ion cell is a basic unit of a lithium ion power source. It consists of an anode, a cathode, and an electrolyte that facilitates the movement of lithium ions between them.

A lithium ion battery (LIB) is typically made up of one or more cells connected together. These cells work together to provide a higher voltage or capacity. So, a battery can be made from a single lithium ion cell, or multiple cells connected in series or parallel.

During formation, operation or/and storage, lithium ion cells and/or batteries (LIBs) with organic electrolyte release CO₂. The release may be hazardous and also reduces the effectiveness of the LIB and raises safety issues.

There is a growing need to reduce the accumulated amount of CO₂ byproduct release.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Since the illustrated embodiments of the present invention may for the most part, be implemented using chemical elements known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a battery and/or a cell should be applied mutatis mutandis to a method for operating the battery and/or the cell.

Any reference in the specification to an electrolyte and/or an electrolyte additive should be applied mutatis mutandis to a method for manufacturing and/or utilizing the electrolyte and/or an electrolyte additive.

There may be provided any combination of content related to two or more embodiments.

The suggested solution can be applied to any LIB with organic electrolyte.

CO₂ can be produced independently regardless of the anode/cathode active material of the LIB Organic electrolyte components can be carbonates, ethers, esters, etc. including organic electrolyte additives (most of the electrolyte additives participate in reduction/oxidation mechanisms. Those mechanisms involve CO₂ release).

There are many mechanisms (thermal/high voltage/impurities/mechanical stress) for CO₂ evolution in LIB.
a. High temperature may include excessive heat, whether from external sources or rapid charging, which accelerates chemical reactions, including decomposition.
b. Impurities may include trace amounts of water, metal ions, or other contaminants that can act as catalysts, promoting decomposition.
c. Mechanical stress may result in physical damage to the battery can rupture the protective film on the electrodes, exposing them directly to the electrolyte and triggering reactions.

Decomposition of both electrolyte and Li salt can initiate those reactions.
a. Organic carbonate solvents, which are the main component of most Li-ion battery electrolytes, can decompose at high temperatures or/and voltages, releasing CO₂ as a byproduct.
b. Another well-known mechanism includes water. Meaning that, even ppm(S) of water in the cell, will result in CO₂ release. The specific pathways and products of decomposition depend on the type of solvent and other factors, but CO₂ is often generated alongside other gases like CO, ethylene, and methane.
c. Decomposition of the lithium salt (such as LiPF₆) can also occur, particularly at high voltages. This decomposition typically leads to the formation of LiF and PF₅, further reactions can generate CO₂ and other harmful species.
d. In addition to electrolyte decomposition, CO₂ generation can occur as a consequence of the additional chemical reaction of interaction of previously generated gases. For example, the O2 released from the cathode atomic lattice oxygen and CO released from the same place on the cathode.

Furthermore—the creation of CO₂ can occur in any life stage/operation test of the cell (formation, room temp cycling, high temp cycling, any state of charge (SOC), storage, etc). Electrolyte decomposition has several negative consequences for the battery:
a. Capacity loss: solid deposits on electrodes block Li ion movement, reducing the battery's capacity to store and deliver charge.
b. Increased impedance: deposits and other products can increase the resistance within the battery, leading to higher power losses and lower efficiency.
c. Safety hazards: gas evolution can create pressure buildup and potentially lead to cell rupture or fire.

While CO₂ generation can occur in any battery format, including pouch, cylindrical, and prismatic cells, hard-case cells present unique challenges in managing its impact.
a. Their rigid walls restrict expansion during decomposition, leading to higher internal pressure and potentially accelerating further decomposition with safety risks.
b. Additionally, hard-case cells lack efficient mechanisms for venting accumulated gas, further exacerbating pressure buildup and potential safety concerns.
c. Moreover, CO₂ buildup can disrupt the internal structure, hindering electrical performance and capacity.
d. Finally, their limited ability to swell and accommodate volume changes during operation compared to pouch cells can lead to mechanical stress, potentially causing internal damage and performance degradation.

There is provided an electrolyte that includes one or more electrolyte additives that reduce gas accumulation in LIB via an in-situ conversion of CO₂ to carbonate (from gas to liquid). The reaction mechanism of the conversion of CO₂ to carbonate by an epoxide involves the following steps: Epoxide activation, ring opening of epoxide, nucleophilic attack of O-atom of open epoxide on C-atom of CO₂ (CO₂ insertion), and ring closure to carbonate.

Such a transformation not only increases the safety of Li batteries as it mitigates gas accumulation, but it does so by turning CO₂ into valuable molecules.

In one or more embodiments, there is provided a metal-free catalyst system capable of converting a variety of epoxides to cyclic carbonates under ambient conditions. The electrolyte additives having epoxide functional group(s) function as reagents that regulate the CO₂ level within the cell.

In one or more embodiments the one or more electrolyte additives are metal-free electrolyte additive for use in a LIB.

In one or more embodiments the epoxide functional group functions as a reagent that regulates a CO₂ level within a cell of the battery.

In one or more embodiments, the LIB includes an anode that contains Si.

In one or more embodiments, the epoxide functional group functions as a reagent that regulates a CO₂ level within a cell of the battery, wherein the epoxide function group is chosen from

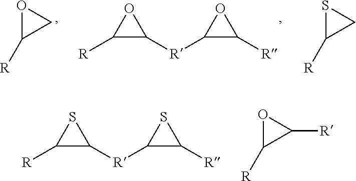

are each independently H, alkyl, halogenyl, haloalkyl, cycloalkyl, benzyl, aryl, heteroalicyclic, heteroaryl, polymeric moiety or an oligomeric moiety.

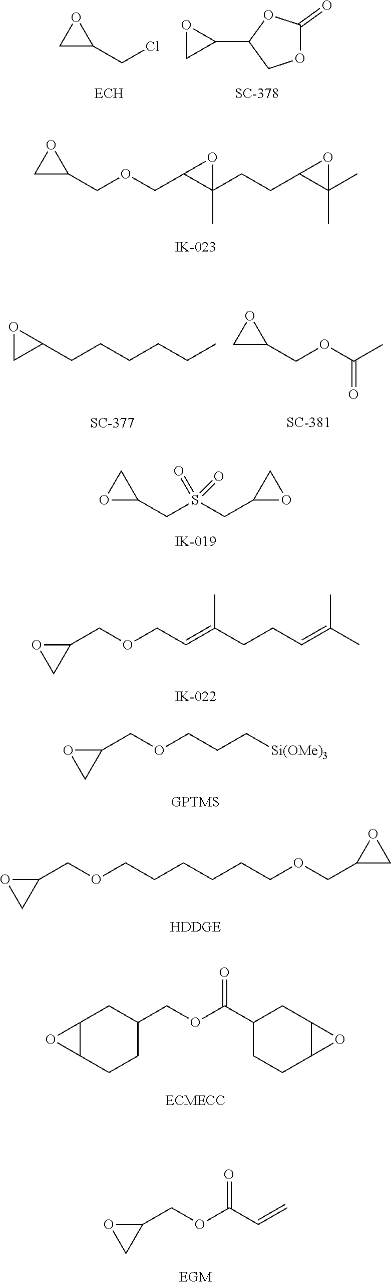

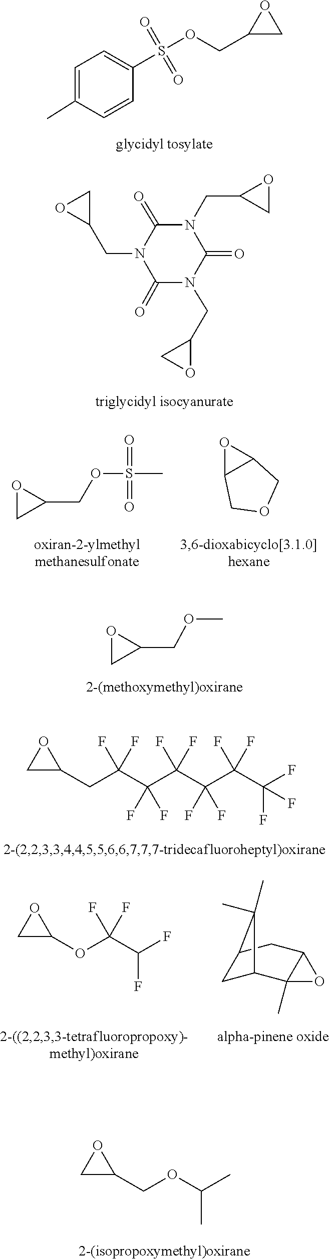

It should be noted that the above paragraph provides non limiting examples. Any organo-catalyst that is able to facilitate this transformation ex-situ, and not harming the cell operation, can be used.

It should be noted that the chemical name of the sulfur containing epoxides is Thiirane.

In one or more embodiments the metal-free electrolyte additive may also include (in addition to the mentioned above epoxide function group) at least one organo-catalyst selected from:

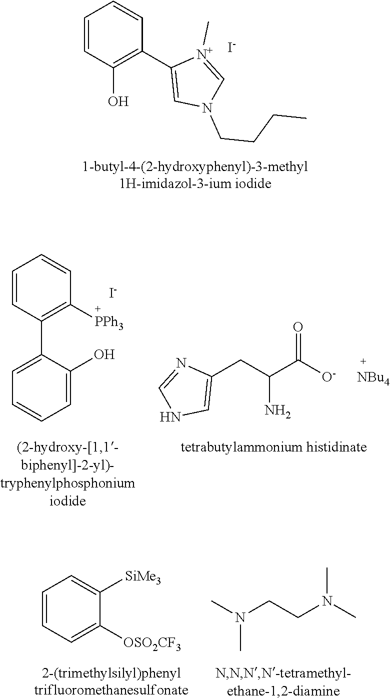

1-butyl-4-(2-hydroxyphenyl)-3-methyl-1H-imidazol-3-ium iodide;
(2′-hydroxy-|1,1′-biphenyl]-2-yl)triphenylphosphonium iodide; Tetrabutylammonium histidinate;
2-(trimethylsilyl)phenyl trifluoromethanesulfonate;
N,N,N′,N′-tetramethyl-ethane-1,2-diamine.

It should be maintained that every organo-catalyst that is able to facilitate this transformation ex-situ, and not harming the cell operation, can be used. This transformation, the conversion of CO₂ to carbonate by an epoxide, works in some cases without additional catalyst, because for some epoxides the lithium salt (e.g. LiPF₆) can function as catalyst.

In one or more embodiments, the metal-free electrolyte additive is for use in a LIB, and the additive may include at least one epoxide functional group in an amount sufficient to convert gaseous carbon dioxide generated during use of the LIB into liquid carbonate under ambient conditions.

In one or more embodiments, there is provided a method of in-situ conversion of CO₂ to carbonate in a LIB, the method includes: contacting CO₂ generated during use of a LIB with a metal-free electrolyte including at least one epoxide functional group in an amount sufficient to convert gaseous carbon dioxide generated during use of the LIB into liquid carbonate under ambient conditions.

In one or more embodiments, the method may include using any of the electrolytes and/or electrolyte additives mentioned in the application.

In one or more embodiments, the method may include using any of the cells and/or batteries mentioned in the application.

In one or more embodiments, there is provided a method in-situ conversion of CO₂ to carbonate in a LIB using the disclosed additives. For example, in some embodiments, the method includes contacting CO₂ generated during use of a LIB with a metal-free electrolyte including at least one epoxide functional group in an amount sufficient to convert gaseous carbon dioxide generated during use of the LIB into liquid carbonate under ambient conditions.

Table 1 shows data that illustrate examples of epoxide additives in the electrolyte of the LIB.

TABLE 1

| | | Swelling - LIB | Number of charge/ |
|---|---|---|---|
| | Epoxide amount | thickness increase | discharge cycles |
| | wt % in | in % at end of | to −80% of initial |
| Epoxide | electrolyte | storage vs after | capacity (after |
| name | of the LIB | formation | formation) of the LIB |
| no | 0 | >20 | 500 |
| ECH | 3 | ~8 | >300 |
| ECH | 1.5 | ~11 | 450 |
| ECH | 0.2 | ~13 | 500 |
| ECH | 0.002 | ~17 | 500 |
| SC-378 | 1.5 | ~13 | 500 |
| SC-378 | 3 | ~11 | >300 |
| SC-378 | 0.2 | ~15 | 500 |

Table 1 provides information about tests that involved a 3Ah pouch cell with a silicon anode, NMC cathode, and in typical carbonate based electrolyte, including EC and DMC, with LiPF₆ salt.

Battery swelling was evaluated after one month in storage at 45° C. and 100% SOC.

Cycling performance was measured at 4.2C charge and 1C discharge cycles with a test temperature of 35° C.

It has been shown that below a concentration of the metal-free electrolyte additive (in relation to the organic electrolyte) of 0.0001 wt %, there is no noticeable effect of CO₂ reduction. However, exceeding 2 wt % can have harmful effects. An example of a desired rage ranges between 0.0001 wt % to 2.0 wt %.

In the foregoing specification, the invention has been described with reference to specific examples of embodiments of the invention. It will, however, be evident that various modifications and changes may be made therein without departing from the broader spirit and scope of the invention as set forth in the appended claims.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A lithium ion cell, comprising:
electrodes;
an organic electrolyte; and
a metal-free electrolyte additive that comprises an epoxide functional group configured to convert gaseous carbon dioxide generated during use of the lithium ion cell into liquid carbonate under ambient conditions.

2. The lithium ion cell according to claim 1, wherein a weight of the metal-free electrolyte additive ranges between 0.001 percent to 2 percent of a weight of the organic electrolyte.

3. The lithium ion cell according to claim 1, wherein a weight of the metal-free electrolyte additive ranges between 0.01 percent to 0.5 percent of a weight of the organic electrolyte.

4. The lithium ion cell according to claim 1, wherein a weight of the metal-free electrolyte additive does not exceed 2 percent of a weight of the organic electrolyte.

5. The lithium ion cell according to claim 1, wherein the epoxide function group is selected from: 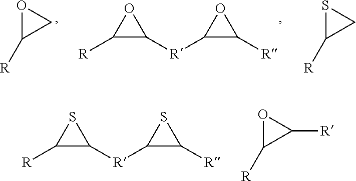
wherein R, R′, R″ are each independently H, alkyl, halogenyl, haloalkyl, cycloalkyl, benzyl, aryl, heteroalicyclic, heteroaryl, polymeric moiety or an oligomeric moiety.

6. The lithium ion cell according to claim 1, wherein the epoxide function group is chosen from:
ECH: Epichlorohydrin (2-(chloromethyl) oxirane);
SC-378:4-(Oxiran-2-yl)-1,3-dioxolan-2-one;
IK-023:2-(2-(3,3-Dimethyloxiran-2-yl)ethyl)-2-methyl-3-((oxiran-2-ylmethoxy)methyl) oxirane;
SC-377:2-Hexyloxirane;
SC-381: Oxiran-2-ylmethyl acetate;
IK-019:2,2′-(sulfonylbis(methylene))bis(oxirane);
IK-022:2-(((3,7-Dimethylocta-2,6-dien-1-yl)oxy) methyl) oxirane;
GPTMS: Trimethoxy (3-(oxiran-2-ylmethoxy) propyl) silane;
HDDGE: 1,6-Bis(oxiran-2-ylmethoxy) hexane;
ECMECC: (7-Oxabicyclo[4.1.0]heptan-3-yl)methyl 7-oxabicyclo[4.1.0]heptane-3-carboxylate;
EGM: Oxiran-2-ylmethyl acrylate.

7. The lithium ion cell according to claim 1, further comprising an organo-catalyst selected from:
1-butyl-4-(2-hydroxyphenyl)-3-methyl-1H-imidazol-3-ium iodide;
(2′-hydroxy-[1,1′-biphenyl]-2-yl)triphenylphosphonium iodide;
Tetrabutylammonium histidinate;
2-(trimethylsilyl)phenyl trifluoromethanesulfonate;
N,N,N′,N′-tetramethyl-ethane-1,2-diamine.

8. A mixture, comprising:
an organic electrolyte; and a metal-free electrolyte additive for use in a lithium ion cell; wherein a weight of the metal-free electrolyte additive ranges between 0.001 percent to 2 percent of a weight of the organic electrolyte; wherein the electrolyte additive comprises at least one epoxide functional group configured to convert gaseous carbon dioxide generated during use of the lithium ion cell into liquid carbonate under ambient conditions.

9. The mixture according to claim 8, wherein the epoxide function group is selected from: 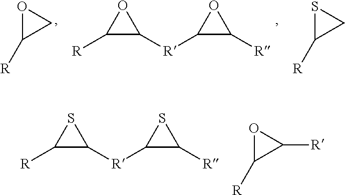
wherein R, R′, R″ are each independently H, alkyl, halogenyl, haloalkyl, cycloalkyl, benzyl, aryl, heteroalicyclic, heteroaryl, polymeric moiety or an oligomeric moiety.

10. The mixture according to claim 8, wherein the epoxide function group is chosen from:
ECH: Epichlorohydrin (2-(chloromethyl) oxirane);
SC-378:4-(Oxiran-2-yl)-1,3-dioxolan-2-one;
IK-023:2-(2-(3,3-Dimethyloxiran-2-yl)ethyl)-2-methyl-3-((oxiran-2-ylmethoxy)methyl) oxirane;
SC-377:2-Hexyloxirane;
SC-381: Oxiran-2-ylmethyl acetate;
IK-019:2,2′-(sulfonylbis(methylene))bis(oxirane);
IK-022:2-(((3,7-Dimethylocta-2,6-dien-1-yl)oxy) methyl) oxirane;
GPTMS: Trimethoxy (3-(oxiran-2-ylmethoxy) propyl) silane;
HDDGE: 1,6-Bis(oxiran-2-ylmethoxy) hexane;
ECMECC: (7-Oxabicyclo[4.1.0]heptan-3-yl)methyl 7-oxabicyclo[4.1.0]heptane-3-carboxylate;
EGM: Oxiran-2-ylmethyl acrylate.

11. The mixture according to claim 8, wherein the metal-free electrolyte additive further comprising an organo-catalyst selected from:
1-butyl-4-(2-hydroxyphenyl)-3-methyl-1H-imidazol-3-ium iodide;
(2′-hydroxy-[1,1′-biphenyl]-2-yl)triphenylphosphonium iodide;
Tetrabutylammonium histidinate;
2-(trimethylsilyl)phenyl trifluoromethanesulfonate;
N,N,N′,N′-tetramethyl-ethane-1,2-diamine.

12. A method for reducing lithium ion cell swelling, the method comprising:
reducing an amount of CO₂ released from organic electrolyte of the lithium ion cell by converting, by a metal-free electrolyte additive that comprises an epoxide functional group, to liquid carbonate under ambient conditions.

13. The method according to claim 12, wherein a weight of the metal-free electrolyte additive ranges between 0.001 percent to 2 percent of a weight of the organic electrolyte.

14. The method according to claim 12, wherein a weight of the metal-free electrolyte additive ranges between 0.01 percent to 0.5 percent of a weight of the organic electrolyte.

15. The method according to claim 12, wherein a weight of the metal-free electrolyte additive does not exceed 2 percent of a weight of the organic electrolyte.

16. The method according to claim 12, wherein the epoxide function group is selected from: 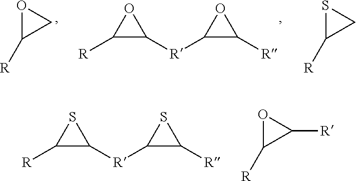
wherein R, R′, R″ are each independently H, alkyl, halogenyl, haloalkyl, cycloalkyl, benzyl, aryl, heteroalicyclic, heteroaryl, polymeric moiety or an oligomeric moiety.

17. The method according to claim 12, wherein the epoxide function group is chosen from:
ECH: Epichlorohydrin (2-(chloromethyl) oxirane);
SC-378:4-(Oxiran-2-yl)-1,3-dioxolan-2-one;
IK-023:2-(2-(3,3-Dimethyloxiran-2-yl)ethyl)-2-methyl-3-((oxiran-2-ylmethoxy)methyl) oxirane;
SC-377:2-Hexyloxirane;
SC-381: Oxiran-2-ylmethyl acetate;
IK-019:2,2′-(sulfonylbis(methylene))bis(oxirane);
IK-022:2-(((3,7-Dimethylocta-2,6-dien-1-yl)oxy) methyl) oxirane;
GPTMS: Trimethoxy (3-(oxiran-2-ylmethoxy) propyl) silane;
HDDGE: 1,6-Bis(oxiran-2-ylmethoxy) hexane;
ECMECC: (7-Oxabicyclo[4.1.0]heptan-3-yl)methyl 7-oxabicyclo[4.1.0]heptane-3-carboxylate;
EGM: Oxiran-2-ylmethyl acrylate

18. The method according to claim 12, wherein the lithium ion cell further comprises an organo-catalyst selected from:
1-butyl-4-(2-hydroxyphenyl)-3-methyl-1H-imidazol-3-ium iodide;
(2′-hydroxy-[1,1′-biphenyl]-2-yl)triphenylphosphonium iodide;
Tetrabutylammonium histidinate;
2-(trimethylsilyl)phenyl trifluoromethanesulfonate;
N,N,N′,N′-tetramethyl-ethane-1,2-diamine.

19. The method according to claim 12, further comprising providing the metal-free electrolyte additive to the lithium ion cell.
